(19) United States
(12) Patent Application Publication
(10) Pub. No.: US 2004/0134749 A1
(43) Pub. Date: Jul. 15, 2004

(54) Deflector for an escalator or moving sidewalk

(76) Inventors: Matthias Lunacek, ObernKirchen (DE); Thorsten Gessner, Berlin (DE)

Correspondence Address: Sean W O'Brien, Otis Elevator Company, Intellectual Property Department, Ten Farms Springs, Farmington, CT, 06032, US

(21) Appl. No.: 10/451,345

(22) PCT Filed: Dec. 18, 2001
(86) PCT No.: PCT/US01/49179

(30) Foreign Application Priority Data
Dec. 21, 2000 (DE) 10064100.8

(51) Int. Cl. B65G 15/00

(52) U.S. Cl. 198/326

(57) ABSTRACT

The invention pertains to a people conveyor (2) with a rotating passenger transport band (4), at least one balustrade (6) arranged to the side of the passenger transport band and a base panel (8) at the transition between the passenger transport band and the balustrade, wherein a gap (10) is located between the passenger transport band and the base panel, and wherein the base panel essentially extends vertically upward from the gap. This people conveyor is characterized by the fact that a deflector (12) is provided which is constructed in one piece with the base panel and horizontally overlaps the gap by a certain length, wherein the deflector is arranged in such a way that a predetermined minimum vertical spacing between the deflector and the passenger transport band is observed.

The present invention pertains to a people conveyor with a rotating passenger transport band, at least one balustrade arranged to the side of the passenger transport band and a base panel at the transition between the passenger transport band and the balustrade, wherein a gap is located between the passenger transport band and the base panel, and wherein the base panel extends essentially vertically upward from the gap.

### BACKGROUND OF THE INVENTION

Escalators and moving sidewalks are typical examples of such people conveyors. An escalator typically contains a series of movable stairs that are connected to one another and driven by a drive motor such that they rotate around upper and lower reversing wheels. The stairs that are connected to one another are referred to as a stair band. Similarly, moving sidewalks contain several pallet elements that are connected to one another and also revolve around two reversing wheels. In moving sidewalks of this type, the passenger transport band is typically referred to as a pallet band. In another type of moving sidewalk, the pallet-band is formed by an essentially continuous elastic material. A balustrade, on which a handrail that usually rotates together with the passenger transport band is guided, is typically arranged to the side of the passenger transport band. Certain materials, e.g., glass, are frequently chosen for the balustrade for aesthetic reasons. The lower region of the balustrade is held in a balustrade base. A so-called base panel covers the balustrade mounting. This base panel is of particular relevance with respect to safety considerations. A relatively narrow gap separates the base panel from, for example, the stairs or the pallet elements of the passenger transport band. This gap has a certain predetermined maximum size. Typical maximum gap widths are 3 to 4 mm. The gap width is of particular importance in the construction of people conveyors. In order to ensure the maximum safety of such people conveyors, various safety measures are adopted, particularly, for preventing objects, clothing, or even parts of the body from becoming trapped in this gap. One solution consists of keeping the gap width as small as possible and ensuring that the gap width does not become larger with time. Another solution consists of providing devices that essentially render the gap inaccessible.

This gap is particularly problematic in escalators because the horizontal tread region of the stair is obliquely guided upward along the base panel. This means that an object or part of the body that moves into the vicinity of the gap tends to be pulled into the gap due to the movement of the escalator.

There exist conventional deflectors that can be subsequently installed into existing systems. These deflectors usually consist of a plastic material into which flexible deflection elements, in particular, brushes, are cast for essentially preventing access to the gap. Deflectors of this type are quite popular and installed if so requested by the customer. However, their manufacture is relatively expensive, with said deflectors also requiring an additional labor expenditure in the installation of system.

Consequently, the invention is based on the objective of making available a deflector for people conveyors which can be inexpensively realized with a low labor expenditure.

### SUMMARY OF TH INVENTION

According to the invention, this objective is attained due to the fact that a deflector is provided which is constructed in one piece with the base panel and horizontally overlaps the gap by a certain length, wherein the deflector is arranged in such a way that a predetermined minimum vertical spacing between the deflector and the passenger transport band is observed.

Surprisingly, it was determined that this makes it possible to provide a deflector on the base panel without increasing costs. This is based on the shape of the deflector, i.e., the essentially perpendicular projection of the deflector from the base panel surface located next to the gap, which significantly stabilizes the base panel in the vicinity of the gap where such a stabilization is particularly desirable. Thus, other measures for stabilizing the base panel can be reduced. The savings obtained in this way compensate for the additional expenditures for integral manufacture of the deflector. It is also advantageous for the invention that the base panel is manufactured from a material that must meet certain minimum requirements with respect to its sliding properties. Various national and international regulations stipulate, in particular, certain maximum frictional resistance values for this material. In contrast to the plastic material used for manufacturing deflectors that are subsequently installed, the deflectors that are constructed in one piece with the base panel already have a sufficiently low coefficient of resistance such that it is not absolutely imperative to provide deflecting brushes or other flexible deflecting elements.

In order to prevent objects from becoming trapped between the deflector and the passenger transport band, a predetermined minimum vertical spacing between deflectors and the passenger transport band must be observed. In conventional moving sidewalks in which the treads of the individual pallets are essentially arranged in one plane, the important point is the spacing between this plane and the lowest part of the deflector. In escalators in which the distance between the tread of the stair and the deflector is not constant, the spacing is measured between the front edge of the stair and the deflector.

Another particularly important advantage of the one-piece construction of the deflector and the base panel is that sufficiently high forces can be exerted upon the deflector, particularly in the vertical direction (i.e., on the upper side and the lower side of the deflector from the top or from the bottom) without causing the deflectors to be torn off the base panel. This was not always ensured to a sufficient degree with conventional deflectors that are subsequently installed in people conveyors. In certain instances, the fastening means, e.g., screws or rivets, for fastening the deflector to the base panel were unable to transmit these forces. In addition, only a point-wise transmission of forces is possible with such fastening means such that individual transmission points are subjected to particularly high stresses. For example, if it was neglected to install one fastening screw during the subsequent installation of a deflector, the deflector could fracture under extreme conditions and consequently injure the users of the people conveyor.

The deflector preferably has a lower side that is upwardly inclined at a certain angle relative to the horizontal line. This angle preferably is at least 25°. It would also be conceivable to use larger angles, for example, up to 45° or more. This incline provides the advantage that objects which might otherwise become lodged underneath the deflector tend to be pressed out due to this inclination of the lower side.

It is preferred that the deflector overlap the gap by no less than 20 mm and no more than 60-100 mm. The range between 30 and 50 mm is particularly preferred. An excessively short overlap is unable to sufficiently secure the gap. An excessively long overlap would reduce the width of the passenger transport band. In addition, this would increase the risk of objects or parts of the body becoming trapped between the deflector and the tread of the passenger transport band.

The minimum distance between the deflector and the passenger transport band is preferably between 20 and 30 mm, where approximately 25 mm is specifically preferred. This distance is measured from the lowest part of the deflector.

The base panel is preferably stamped from a sheet metal material, where the deflector is preferably manufactured simultaneously with the stamping of the base panel. Alternatively, the base panel may be extruded from aluminum or an aluminum alloy or from another extrudable material, where the deflector is manufactured simultaneously during the extrusion process. Both instances represent inexpensive manufacturing methods, particularly when large quantities are produced, where the costs for the additional manufacture of the deflector are negligible.

The deflector preferably extends over essentially the entire length of the base panel. The deflector is preferably connected at the beginning and end to the rest of the base panel by means of an inclined transition. This minimizes the risk of injury. It is particularly preferred that the deflector continue beyond the comb plates by a certain distance so as to render the particularly critical region of the gap in which the passenger transport band disappears underneath the comb plate inaccessible.

The lower side of the deflector preferably contains at least one illumination opening. It would also be possible to provide at least one illumination opening in the end surface of the deflector as an alternative or in addition to the aforementioned illumination opening. The openings may be closed with a transparent material, e.g., the light source located behind these illumination openings within the base panel can be used for illuminating the passenger transport band in this case. For example, neon tubes, light-emitting diodes or other light sources may be considered for this purpose. The arrangement in the lower side of the deflector is particularly advantageous because it is frequently problematic to realize sufficient illumination of the passenger transport band and, in particular, to provide emergency lighting in case of power failures. Illuminating arrangements were already incorporated into the base panel, where the illumination openings were covered by a transparent plastic material. However, these covers were frequently became very worn due to their unfavorable position. The frequently scratched or soiled covers gave the people conveyor a “shabby” appearance. The arrangement of the illumination openings on the lower side of the deflectors has two advantages. First, it is practically impossible to unintentionally gain access and consequently scratch or soil the illumination openings and the transparent material. The second advantage can be seen in the fact that the illumination openings and the transparent material are virtually not directly visible to the user such that an observer would be unable to recognize any possible damage.

Flexible deflecting elements are preferably provided on the lower side and, alternatively or additionally, on the end surface of the deflector, with said deflecting elements protruding from the deflector by a certain distance. For example, it would be possible to provide brush-like deflecting elements as are already used on installed deflectors. These deflecting elements make it possible to further increase the safety of the people conveyor. The deflecting elements may be cast into a plastic rail, e.g., which is mounted on the integral deflector, for example, by means of screws or bonding. In particular, when using extruded profiles, it would be possible to realize the profiles such that the rails with the brush elements can be inserted into the profiles or mounted thereon by means of a snap-in fastener.

### BRIEF DESCRIPTION OF THE DRAWINGS

The invention and the refinements of the invention are described in greater detail below with reference to the embodiments illustrated in the drawing. It shows:

FIG. 1, part of a people conveyor according to the invention;

FIG. 2, part of an alternative embodiment of the people conveyor, and

FIG. 3, part of another alternative embodiment of the people conveyor.

### DETAILED DESCRIPTION OF THE PREFERRED EMBODIMENTS

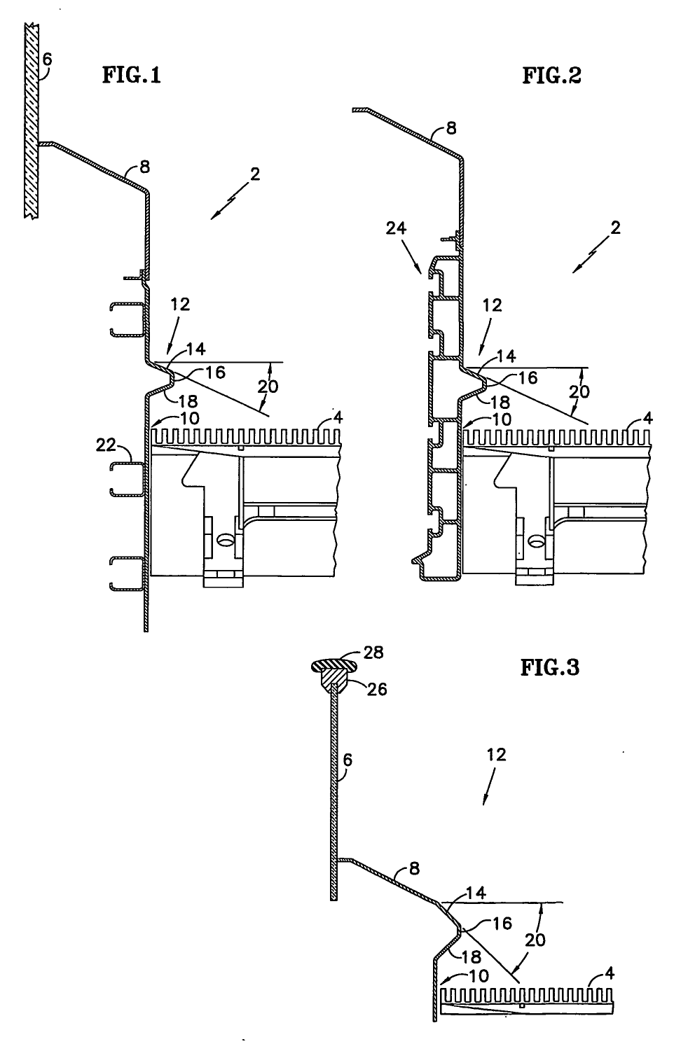

FIG. 1 shows part of a people conveyor 2 according to the invention with a rotating passenger transport band 4, a balustrade 6 that is arranged to the side of the passenger transport band 4 and base panel 8 that is arranged between the passenger transport band 4 and the balustrade. The passenger transport band 4 is composed of several individual stairs or pallet elements that are connected to one another, e.g., analogous to a stair chain, and rotationally driven by a (not shown) drive unit. During its rotating movement, the passenger transport band 4 is able to transport passengers from a (not shown) entry point to a (not shown) exit point. The passenger transport band 4 is exposed between the entry point and the exit point. The passenger transport band 4 is normally hidden from the user in the return section. The passenger transport band 4 emerges at the entry point in the region of a (not shown) comb plate and disappears underneath another (not shown) comb plate at the exit point.

There is a gap 10 situated between the passenger transport band 4 and the base panel 8. This gap 10 is particularly critical to safety considerations as is also the case with all other regions of the people conveyor 2 in which parts move relative to one another. This is the reason the deflector 12 is provided in the base panel 8, where said deflector is constructed in one piece with the base panel 8 and extends horizontally from the base panel such that it overlaps the gap 10 by a certain length. The deflector 12 has an upper side 14, an end surface 16 and a lower side 18. The figure shows that the upper side 14 and, particularly the lower side 18 are inclined at a certain angle relative to the horizontal. Specifically, the lower side 18 of the deflector 12 is upwardly inclined relative to the horizontal by an angle of more than 20°, preferably 25-45° or more. The upper side 14 is downwardly inclined relative to the horizontal line by an angle 20 of at least 20°, preferably 25-45° or more. The transitions between the base panel 8 and the upper side 14 and the lower side 18 of the deflector 12, as well as the transitions between the upper and lower sides 14, 18 and the end surface 16 of the deflector, are preferably rounded. It is preferred to round the transitions that are particularly important to safety considerations.

Illumination openings for illuminating the passenger transport band 4 may be arranged in the lower side 18 of the deflector 12 and/or the end surface 16. The openings are covered with a transparent material, for example, a plastic material. The illuminating elements may be arranged in the space enclosed by the base panel 8 and, for example, mounted on the base panel 8. For example, neon tubes may be considered for this purpose, where light-emitting diodes are particularly preferred in light of the limited space conditions.

In FIG. 1, the base panel 8 is manufactured from a sheet metal material. Stainless sheet metal or another corrosion-resistant material are particularly preferred. For example, the deflector 12 may be manufactured simultaneously with the stamping of the base panel 8. The profile of the base panel 8 in FIG. 1 clearly indicates how the deflector 12 is used for reinforcing the structure. It should be mentioned that the reinforcement of the base panel is particularly effective in the region of the gap due to the relatively close proximity of the deflector 12 to the gap 10. It is particularly desirable to construct the base panel 8 to be as stable as possible in this region so that the gap cannot be further widened, for example, if a user intentionally presses against the base panel 8. This figure shows a box-shaped structure 22 that is open toward the inner side and located on the inside, underneath the gap region. This box-shaped structure serves for mounting the base panel 8 on the frame of the people conveyor 2. This reinforcement also serves for stabilizing the base panel 8 such that the gap region is designed in a particularly favorable fashion and reinforced. If the integral deflector 12 were not arranged in the base panel 8 in this region, the inner side would require an additional reinforcement, similarly to the reinforcement 22. It should be noted that the costs for manufacturing the new deflector are essentially identical to those of known deflectors.

The embodiment according to FIG. 2 is designed very similarly to the embodiment according to FIG. 1. Components that are either identical or correspond to one another in FIG. 1 and FIG. 2 are identified by the same reference symbols. The essential difference between these two embodiments can be seen in the fact that the base panel 8 in the embodiment according to FIG. 2 is manufactured in accordance with an extrusion method from an extrudable material, for example, an aluminum alloy. This figure clearly shows, in particular, the typical box-shaped reinforcements 24 on the inner side of the base panel 8 as they are customarily provided in extruded profiles.

It is also possible to utilize the lower side, the end surface and/or the upper side 18, 16, 14 of the deflector 12 for illuminating purposes.

FIG. 3 shows another embodiment that is realized similarly to FIG. 1. It shows that the base panel 8 does not extend upward as far as in the embodiments according to FIGS. 1 and 2. Rather, the base panel 8 is bent obliquely outward at a point situated a relatively short distance behind the deflector 12 and continues to the balustrade 6 from this point. A handrail 28 that rotates with the passenger transport band 4 is located on the upper side of the balustrade 6, with said handrail being mounted on a holding arrangement 26. An essential feature illustrated in FIG. 3 is that the deflector 12 according to the invention can be realized on very different types of base panels regardless of whether a conventional base panel is used. It should also be mentioned that the term “base panel” does not refer merely to panel elements but also includes, for example, structural components or supporting elements if their outer side is located in a region in which the deflector 12 can be reasonably arranged. The invention also includes embodiments in which the base panel ends a very short distance above the gap and another panel or another structural component is provided on top of the base panel as long as the deflector 12 is constructed in one piece with this additional panel or structural component.

The figures male it clear that the deflector 12 is optimally arranged a relatively short distance from the gap such that it extends vertically upward. If the deflector is not arranged sufficiently high above the gap, it may happen that feet in particular will become trapped between the deflector 12 and the passenger transport band 4. If the deflector 12 is arranged too high, it is no longer effective. Consequently, it is particularly preferred to observe a spacing between approximately 25 mm and 50 mm between the lowest part of the lower side of the deflector 12 and the point at which the passenger transport band 4 lies closest to the deflector 12, i.e., to not exceed or fall short of 25 and 50 mm, respectively.

Although the invention has been described with respect to what are at present considered to be the preferred embodiments, modifications may be made without departing from the scope of the invention, which should be determined with reference to the appended claims.

1. People conveyor (2) with a rotating passenger transport band (4), at least one balustrade (6) arranged to the side of the passenger transport band (4) and a base panel (8) at the transition between the passenger transport band (4) and the balustrade (6), wherein a gap (10) is located between the passenger transport band (4) and the base panel (8), and wherein the base panel (8) essentially extends vertically upward from the gap, characterized by the fact that, integrally with the base paneling (8), a deflector (12) is provided which is constructed in one piece with the base panel (8) and horizontally overlaps the gap (10) by a certain length, wherein the deflector (12) is arranged in such a way that a predetermined minimum vertical spacing between the deflector (12) and the passenger transport band (4) is observed.

2. People conveyor (2) according to claim 1, characterized by the fact that the deflector (12) has a lower side (18) that is upwardly inclined relative to the horizontal by an angle of a least 25°.

3. People conveyor (2) according to claim 1 or 2, characterized by the fact that the length of the overlap of the deflector (12) lies between not less than 15 mm and not more than 100 mm.

4. People conveyor (2) according to one of claims 1-3, characterized by the fact that the minimum spacing between the deflector (12) and the passenger transport band (4) lies between 20 and 30 mm.

5. People conveyor (2) according to one of claims 1-4, characterized by the fact that the base panel (8) is stamped from a sheet metal material, and by the fact that the deflector (12) is simultaneously manufactured during the stamping of the base panel (8).

6. People conveyor (2) according to one of claims 1-4, characterized by the fact that the base panel (8) is extruded from aluminum or an aluminum alloy, and by the fact that the deflector (12) is simultaneously manufactured during the extrusion process.

7. People conveyor (2) according to one of claims 1-6, characterized by the fact that the deflector (12) essentially extends over the entire length of the base panel (8).

8. People conveyor (2) according to one of claims 1-7, characterized by the fact that the lower side (18) of the deflector (12) contains at least one illumination opening.

9. People conveyor (2) according to one of claims 1-8, characterized by the fact that flexible deflecting elements are provided on the lower side (18) of the deflector (12), with the deflecting elements protruding from the lower side by a certain length.

10. People conveyor (2) according to one of claims 1-9, characterized by the fact that flexible deflecting elements are provided on the end surface (16) of the deflector (12), with the deflecting elements protruding from the end surface by a certain length.
